(19) United States
(12) Patent Application Publication
(10) Pub. No.: US 2003/0125821 A1
(43) Pub. Date: Jul. 3, 2003

(54) Modular process platform

(76) Inventors: Victor D. Trotter, Fort Worth, TX (US); Jeffery J. Zimmerer, Colleyville, TX (US); Donald W. Murray, Arlington, TX (US); Michael C. Story, Grand Prairie, TX (US); Chris P. Accardo, Grapevine, TX (US)

Correspondence Address: JENKENS & GILCHRIST, PC, 1445 ROSS AVENUE, SUITE 3200, DALLAS, TX, 75202, US

(21) Appl. No.: 10/261,060

(22) Filed: Sep. 30, 2002

Related U.S. Application Data
(60) Provisional application No. 60/326,597, filed on Oct. 1, 2001.

(51) Int. Cl. G05B 13/02; G05B 19/18

(52) U.S. Cl. 700/53; 700/54; 700/56

(57) ABSTRACT

A modular process platform system comprises a frame, a machine base mounted to the frame and an input/output panel mounted to the frame. The input/output panel has a plurality of mappable input/output connectors configured for receiving mating connectors from a machine capable of being mounted to the machine base and from a controller for controlling operation of the machine. The system is configurable for accommodating any of a plurality of different machines having different input/output configurations, without requiring input/output wiring customized to a particular input/output configuration.

### CROSS-REFERENCE TO RELATED APPLICATION

This invention claims the priority of U.S. Provisional Patent Application Serial No. 60/326,597, filed Oct. 1, 2001 entitled “Modular Process Platform.”

### FIELD OF THE INVENTION

The present invention relates to production systems and, more particularly, to a modular process platform that is reconfigurable and capable of multiple applications, including assembly, test, and process control applications.

### BACKGROUND OF THE INVENTION

The use of robotic systems for the assembly and testing of products has become widespread over recent decades. The products assembled with robotic systems span wide ranges of technology as well as product designs. From large automobiles to small integrated circuits, robotic operations have been implemented for purposes of efficiency as well as economy.

The advantages of robotic systems have increased as technology has expanded. The miniaturization of servo-controlled devices as well as the implementation of digital videography has resulted in innovations utilizing enhanced sensing with improved control. An added advantage of such systems is uniformity. Once the robotic system has been adjusted to assemble a product that meets all necessary quality control standards, the inherent repetitive characteristic of the robotic system permits a higher reliability than systems subject to human error.

The aforesaid advantages of robotic systems have resulted in the creation of large assembly lines utilizing a variety of robotic systems permanently integrated into the assembly line. The investment of the necessary capital for establishing such assembly lines has repeatedly been shown to be economically viable.

Unfortunately, many product assembly lines are limited by the value for, or the volume of, the product being assembled. In some situations, operations such as soldering, screwing, sawing, aligning and inserting must be performed manually because there is not sufficient volume and/or gross profit to justify a permanent robotic station in, or along, an assembly line. The inherent disadvantage of such a manufacturing situation is that human error and/or the variability of human interaction becomes prevalent. For example, a robotic arm will repetitively insert a screw precisely in a given location with exactly the same torque if so programmed. The same cannot be said of an assembly line utilizing individuals manually using a screwdriver. But because a robotic system must be economically justifiable, such inefficiencies are permitted.

It would be a distinct advantage therefore to provide a modular robotic system that could be positioned along an existing assembly line to perform an operation therein to increase efficiency and improve quality control. The present invention provides such a system by utilizing a modular assembly system of portable construction which may be positioned adjacent an assembly line and programmed for a variety of operations relative thereto.

### OBJECTS OF THE INVENTION

Accordingly, it is a general object of the invention to provide a modular process platform that is adapted for positioning adjacent an assembly line for performing select, pre-programmed operations.

### SUMMARY OF THE INVENTION

The present invention relates to productions systems. More particularly, one aspect of the present invention includes a modular process platform that is adapted for positioning adjacent an assembly line for performing select, pre-programmed operations.

Briefly and in accordance with the foregoing, a modular process platform system which comprises a frame, a machine base mounted to said frame, an input/output panel mounted to said frame, said input/output panel having a plurality of connectors configured for receiving mating connectors from a machine capable of being mounted to said machine base and from a controller for controlling operation of said machine, whereby said system is configurable for accommodating any of a plurality of different machines having different input/output configurations, without requiring input/output wiring customized to a particular input/output configuration.

In accordance with another embodiment of the invention, a method of carrying out an industrial process which comprises installing tooling for carrying out said industrial process in a modular platform, providing said modular platform with a configurable input/output panel having a plurality of connectors configured for receiving mating connectors from said tooling and mappable to a controller located in said modular platform or remotely from said modular platform, and configuring said input/output configuration to accommodate said tooling mounted to said platform without requiring hard wiring.

In accordance with another embodiment of the invention, a modular process system for carrying out an industrial process which comprises means for mounting tooling for carrying out said industrial process in a modular platform, means for receiving, at a configurable input/output panel having a plurality of connectors, mating connectors from said tooling and maping said connectors to a controller located in said modular platform or remotely from said modular platform, and means for configuring said input/output configuration to accommodate said tooling mounted to said platform without requiring hard wiring.

### BRIEF DESCRIPTION OF THE DRAWINGS

In the drawings:

A more complete understanding of the method and apparatus of the present invention may be obtained by reference to the following detailed description when taken in conjunction with the accompanying drawings wherein:

FIG. 1 is a perspective view of one embodiment of a modular process platform unit constructed in accordance with the principles of the present invention and illustrating various aspects of the assembly thereof;

FIG. 2 is a perspective view of several units similar to that of FIG. 1 disposed adjacent an assembly line;

FIG. 3 is a perspective view of the modular process platform of FIG. 1 with portions thereof removed for illustrating the various features thereof;

FIG. 4 is a perspective view similar to FIG. 3 further illustrating various aspects thereof;

FIG. 5 is a perspective view similar to FIG. 3 illustrating further aspects thereof;

FIG. 6 is a perspective view similar to FIG. 3 further illustrating various aspects thereof;

FIG. 7 is a perspective view of the modular process platform of FIG. 1 taken from a rearward angle relative to the views of FIGS. 3-6 illustrating various aspects thereof;

FIG. 8 is a perspective view of the modular process platform of FIG. 1 with various sections removed to further illustrate the assembly thereof;

FIG. 9 is a perspective view of the modular process platform of FIG. 1 with various sections removed to further illustrate the assembly thereof;

FIG. 10 is a perspective view of the modular process platform of FIG. 1 with additional sections removed to illustrate the various aspects thereof;

FIGS. 11A and 11B are a circuit schematic of an input-output module for use with the modular process platform of FIG. 1;

FIGS. 12A-12C are another circuit schematic of one aspect of the input-output module;

FIGS. 13A and 13B are a another circuit schematic of the input-output module;

FIG. 14 is a front elevational view of the input-output module of the modular process platform of FIG. 1;

FIG. 15 is a schematic of an alternate form of the circuit of FIGS. 13A and 13B; and

FIGS 16A-16C are alternate forms of the circuits of FIGS. 12A-12C.

### DETAILED DESCRIPTION OF THE ILLUSTRATED EMBODIMENT

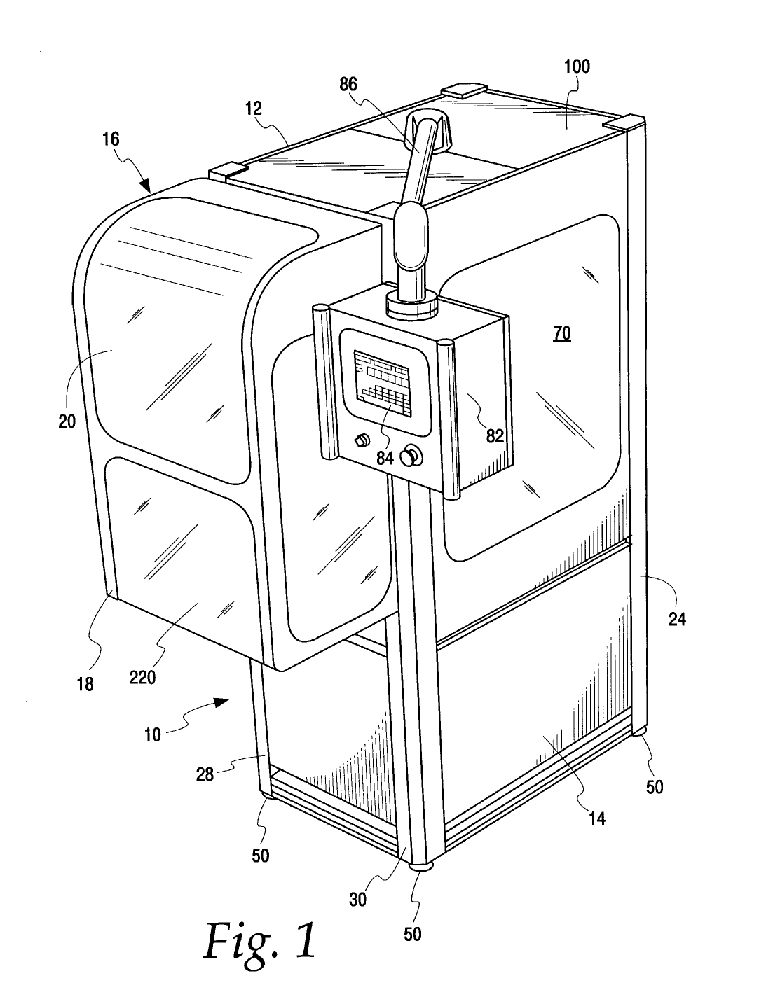

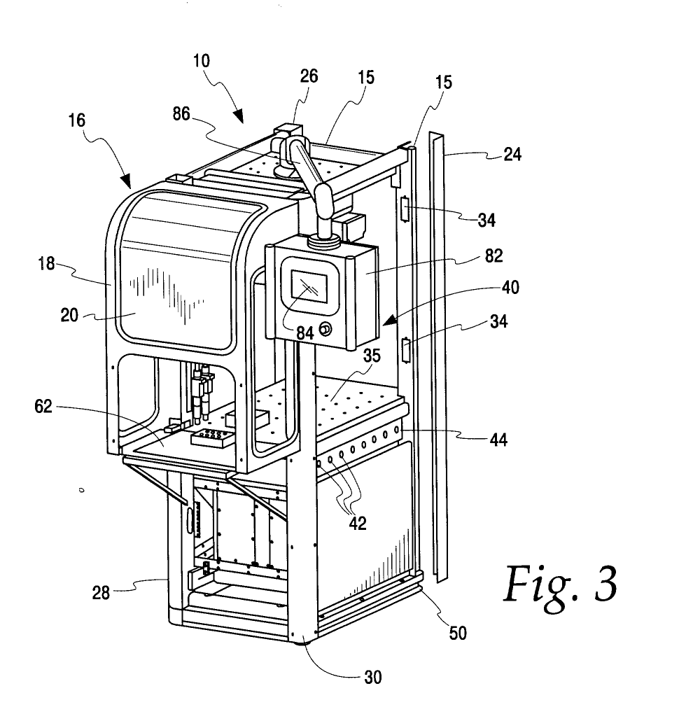

Referring first to FIGS. 1 and 3 there is shown a perspective view of the modular process platform (MPP) or unit 10 of the present invention. The platform or unit 10 comprises a housing 12 having a frame 15 with a number of removable panels 14 assembled therearound. The housing further includes a cantilevered operational area 16 adapted to be disposed over an assembly line or other work area for performing select operations thereon. The cantilevered operational area 16 in this particular view is shown to comprise a cantilevered housing 18 including transparent panel sections 20, 22 facilitating the view of the operation therein and/or thereunder, e.g., on a work surface 35 is a work area 40.

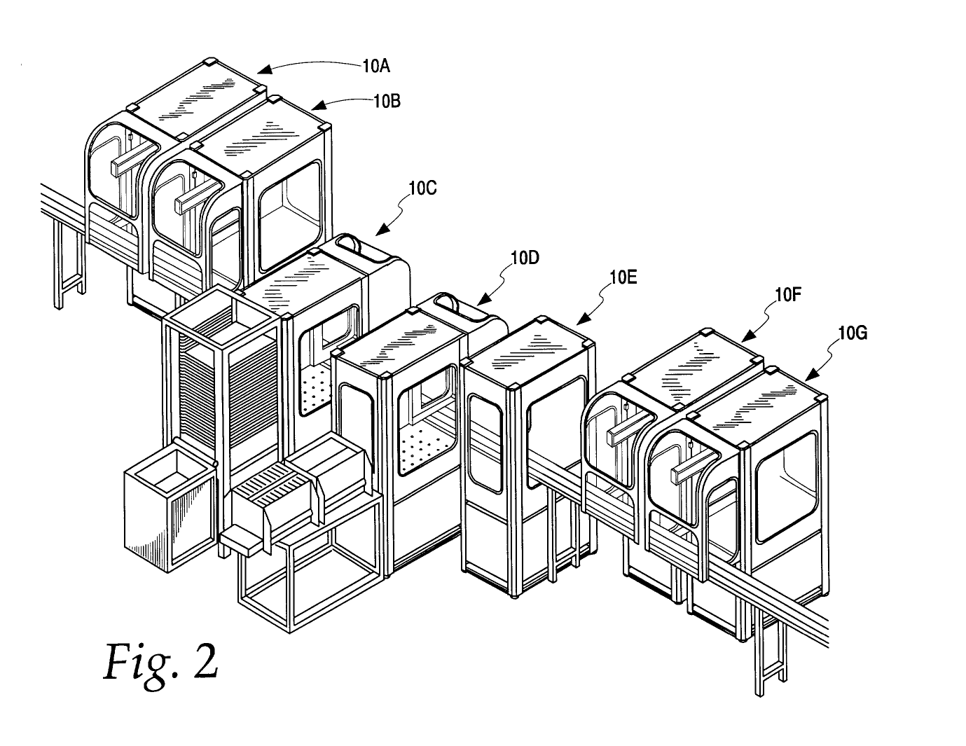

Referring now to FIG. 2, there is shown the modular process platform (MPP) 10a similar to the MPP 10 of FIG. 1 aligned over an assembly line adjacent other similar modular process platforms 10b-10g positioned relative thereto for performing multiple operations on said assembly line. Also, multiple machine frames can be quickly connected together to make one large “work cell.” A controller on one of the frames can be used to control the entire machine if desired. Use of the modular process platform of the invention speeds up deployment time, minimizes footprint, and eases shipping/installation headaches. The configurable machines of the invention allow a host of building block modules based on the same core technology.

Referring to FIG. 3, there is shown a perspective view of the modular process platform 10 of FIG. 1 further illustrating the machine frame, wherein the machine has removable vertical covers 24, 26, 28, 30 on all four corners. These “corner” covers hide and protect wiring routed between levels on the machine. Breakout holes 34 in the frame 15, only two of which are visible in FIG. 3, allow multiple locations for wires to enter the work area 40 inside the unit 10. A horizontally disposed row of holes 42 in a wire trough 44 inside the housing 12 allow multiple wire exit locations. The holes 42 are sized to accept standard cord grips to provide strain relief. Also shown in FIGS. 1 and 3 are leveling feet 50 on all corners of the machine frame 15.

As noted above, electrical raceways are designed into the frame of the machine. This arrangement provides an economical, very easy to use wire duct system for the process platform. The structural members 15 that form the four corners of the process platform serve as one half of the electrical wire duct. Standard openings 34 for gland plate mounting or wire access are provided in the structural portion (corners) of the frame which forms a part of the wire duct. Electrical connectors, AC outlets, and various other components may be mounted in these access holes. The covers 24, 26, 28, 30 for the raceway are mounted from the outside of the process platform to the structural frame corner members to completely encapsulate the wiring for the process platform. The wire covers are removable from the outside to provide easy access to system wiring.

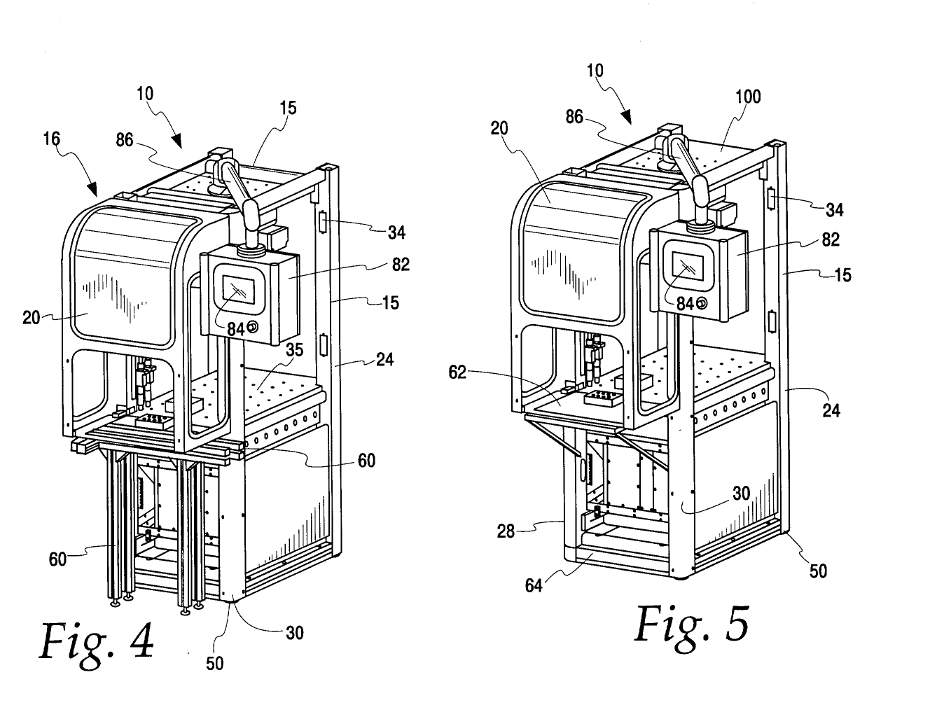

Referring now to FIG. 4, there is shown the modular process platform 10 of FIG. 3 with various parts removed for further illustrating the features thereof A transparent guard panel 16 is easily removable, and a machine can be positioned within the housing 12 next to an existing conveyor or assembly line 60 by using the cantilevered operational area 16 mentioned above. The modular process platform 10 can be quickly tooled and programmed to install tests or inspection components on or to the conveyor.

Referring now to FIG. 5, there is shown an alternative embodiment of the modular process platform 10 of FIG. 4 further illustrating the construction thereof A work surface 62 (also shown in FIG. 3) can be added to any side of the machine to convert to a manually loaded workstation. In this particular view, it may be seen that the representation of an assembly line 60 has been replaced by the work surface 62. Also, a heavy base plate 64 provides stable mounting surfaces and adds substantial weight to keep machine center of gravity low.

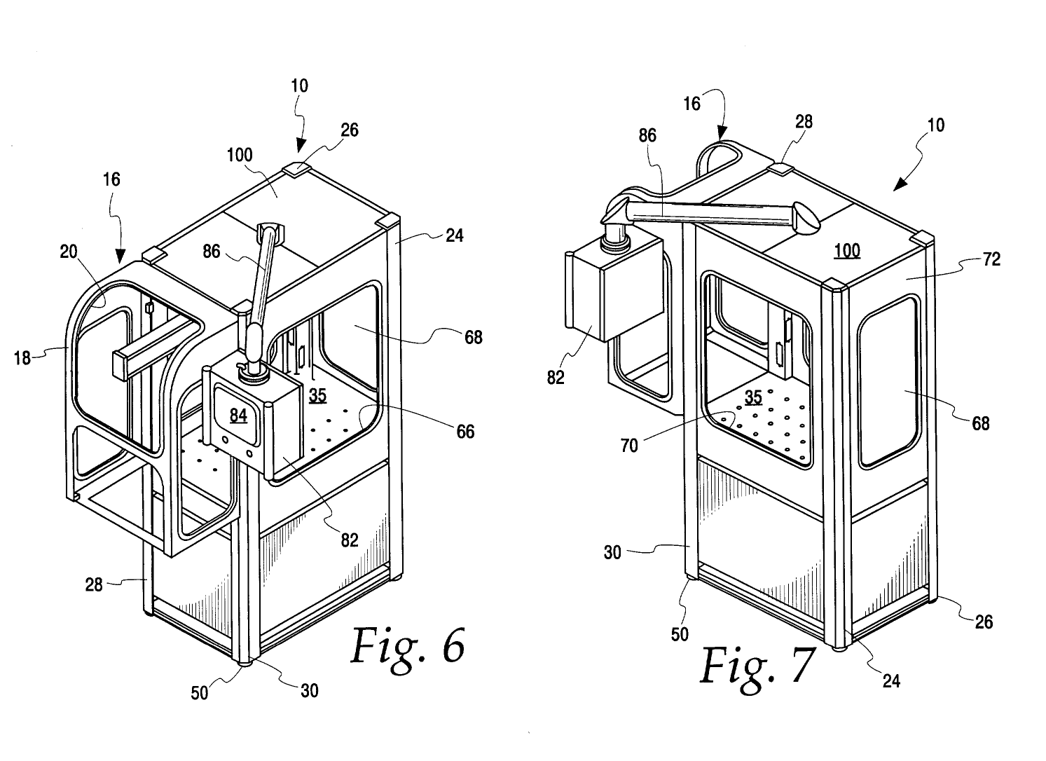

Referring now to FIG. 6, there is shown a modular process platform 10 illustrating further features thereof. Transparent panels or windows 66, 68, 70 on the sides (see also FIG. 7) of the modular process platform 10 allow good visibility of the work area 40 and/or work surface 35 from all sides. These side panels not only provide a cosmetically pleasing look, but also are easily removed for machine access to all sides of the machine.

Referring to FIG. 7, there is shown a perspective view of the modular process platform 10 of FIG. 6 taken from a rearward angle. In this view, an access door 72 at the rear of the machine may be seen. The access door 72 includes safety switches (not shown).

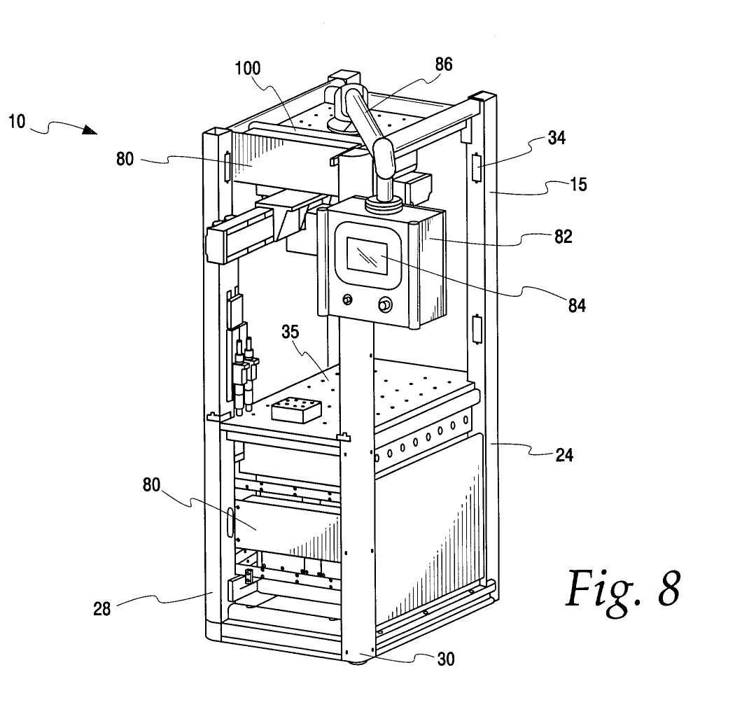

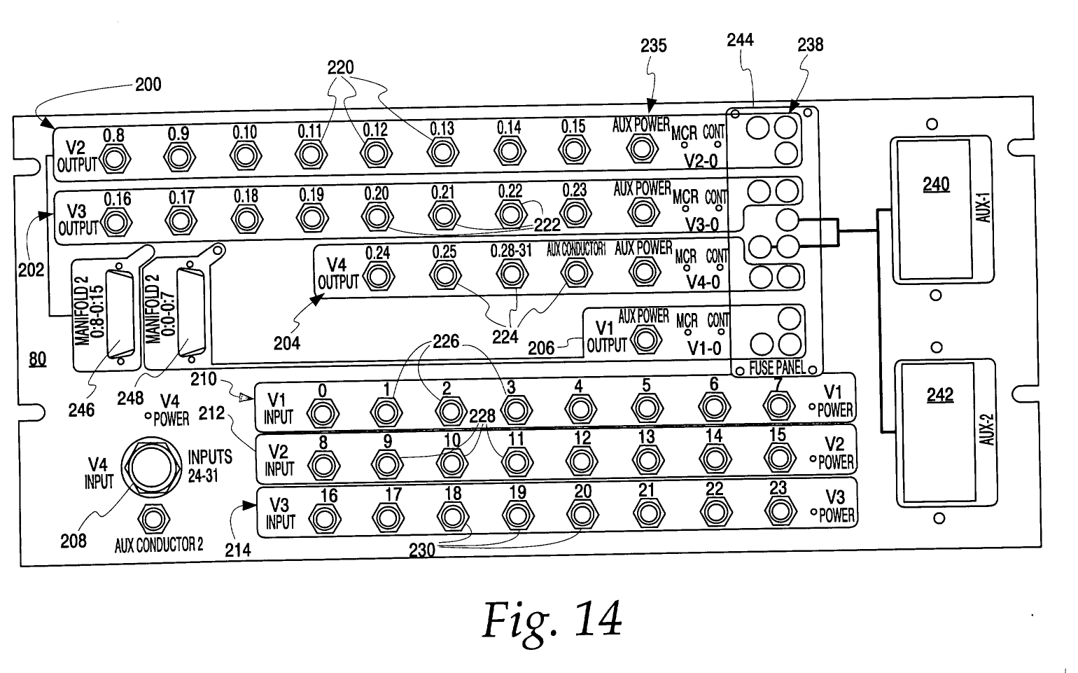

Referring now to FIG. 8, there is shown a perspective view of the modular process platform 10 of FIG. 1 with the section 16 removed to further illustrate some of the construction and features thereof. The machine has modular input-output panels 80 (see also FIG. 14) that can be positioned in either the upper or lower portion of the machine. The panels allow high flexibility and can be configured to user requirements. A control monitor enclosure 82 which houses a visual monitor panel 84 is shown depending from a pivotable monitor arm 86 The monitor arm 86 pivots to allow viewing from all sides of the machine. The monitor panel 84 which is illustrated in more detail in FIG. 1.

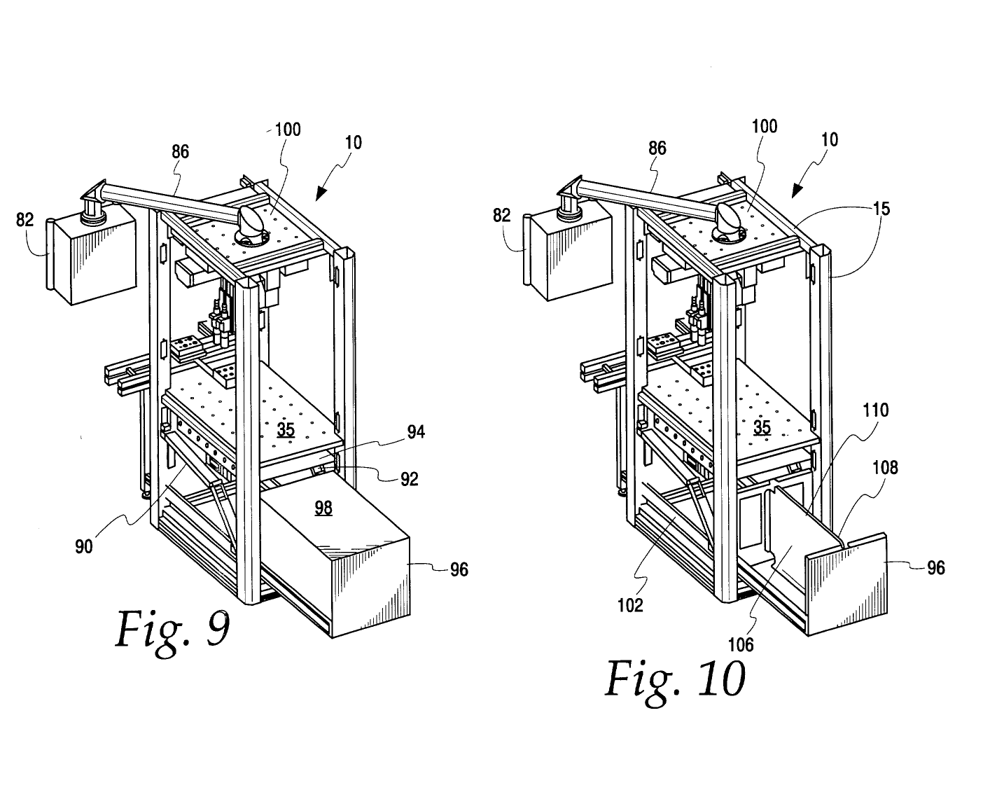

Referring now to FIG. 9, there is shown a rear perspective view of the modular process platform 10 of FIG. 1 further illustrating the assembly thereof. The modular process platform 10 includes an articulating cable management device 90, 92 on each side of the enclosure. A wire and pneumatic line trough 94 is positioned under the entire work surface 35. The trough 94 provides spill containment, flexible wire routing, and minimizes wire and tubing exposure to the work surface. A slide out electric enclosure 96 is fully covered with a removable top 98. The enclosure 96 provides an NEMA Type 12 rating.

Referring now to FIG. 10, there is shown the modular process platform 10 of FIG. 9 with some parts removed for purposes of illustrating the features thereof. Most clearly shown is an upper mounting plate 100 which provides a top closure and pivotally mounts the monitor arm 86, the frame 15, and drawer slides 102 (on both sides of the slide out electrical enclosure 96). The enclosure 96 is shown with top and sides removed to show a DC back plane or panel 106 adjacent to an AC back plane or panel 108. The DC and AC back planes can be optionally separated by a panel 110 to further isolate all DC and AC power, one from the other, and which is removable to allow easy access to both sides.

As described above, the electrical enclosure 96 is mounted as a sliding drawer that allows the enclosure to be easily moved in and out of the machine for easy access to the interior of the enclosure. The two electrical back panels 106, 108 are mounted back to back inside the electrical enclosure to effectively double the back panel area available for mounting electrical components. The movable wireway 90, 92 attached to the sliding drawer and to the frame 15 provides a cable management system for routing wires from the sliding drawer to the frame 15.

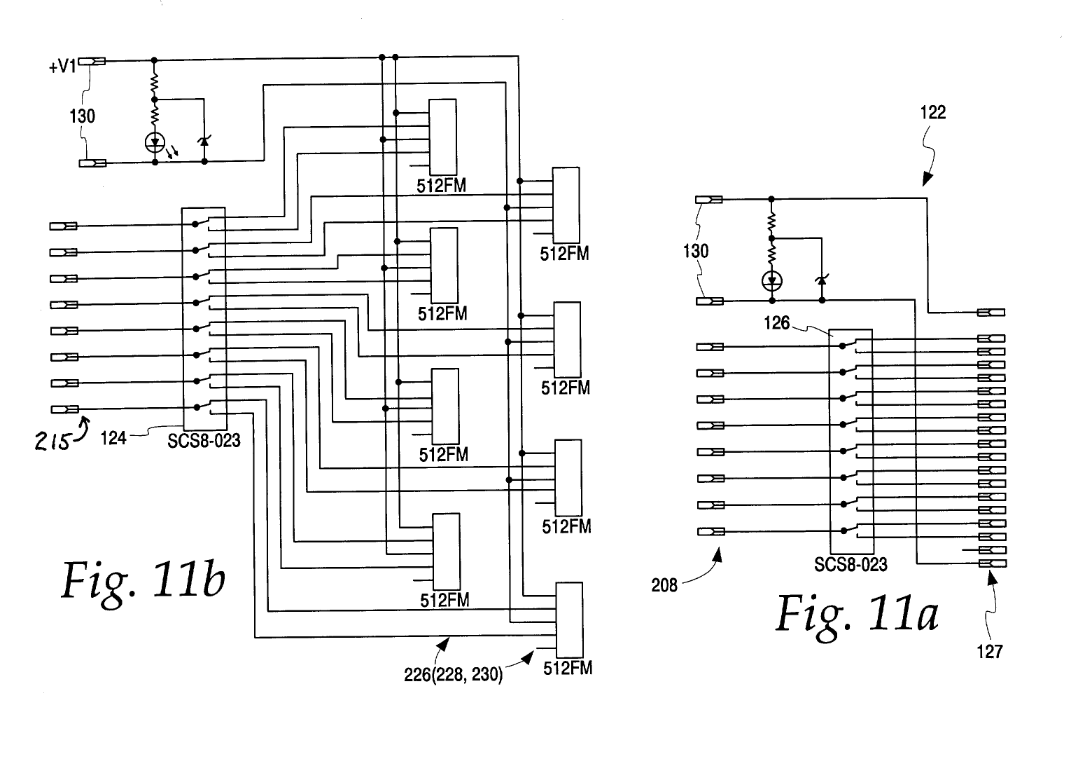

FIGS. 11-13, show circuit schematics of an input-output module, which may be accessed through the input-output panel 80 of FIG. 14 described below. These schematics are described further below.

Referring now to FIG. 14, there is shown in detail the face of the modular input-output (IO) panel 80 for the modular process platform 10 of the present invention. The input-output panel 80 includes a plurality of input and output connectors for facilitating the control and operation of the present invention as described herein.

The I/O panel 80 has several features which are briefly discussed immediately below.

The ESTOP (emergency stop) action of each output can be individually configured via switches behind the I/O panel with no wiring changes. This allows the end user or integrator to select which valves will continue to receive power when the emergency stop circuit is engaged. The circuit meets the applicable safety standards and meets the “control reliability” directives. This feature can be applied to any type of output module using local or distributed I/O.

The I/O panel 80 may be a 4U or 5U standard 19″ rack mount panel. It could also be one 2U input panel and one 3U output panel.

Configuration switches for the panel are accessible from the front of the I/O panel.

Fuses 238 for the panel are accessible from the front of the I/O panel.

Sensor inputs can be defined as PNP (sourcing sensor) or NPN (sinking sensor) from dip switches that are accessible from the I/O panel. Multiple connectors types are provided for a single I/O point, e.g., inputs 208, 210, 212, and outputs 200, 202, 204. For example, an output may be connected via an industry standard Eurofast™ connector (e.g., 220, 222, 224, 226, 228, 230) or via a D-Sub connector. Standard connectors are available for connection of up to two 8 station pneumatic manifolds using off the shelf plug and play cables.

The panel includes 32 local inputs, each input can be PNP or NPN (selectable for each input via a dip switch), 24 local inputs 226, 228, 230 on Eurofast connectors; 8 inputs 246 on single connector for 8 position Eurofast multiport junction box; 32 local outputs; 4 high power relay outputs 235 (sink or source), 2 high power solid state relay AC outputs 240, 242, and 26 sinking 100 ma outputs 220, 222, 224.

Voltages for the inputs and outputs are made available on the front panel via industry standard Eurofast™ connectors 235. Four isolated auxiliary connectors 235 are provided on the front panel For each voltage available, a continuous voltage is available as well as the same voltage that is interrupted when the safety system or emergency stop system is activated. This allows the integrator or user to select the ESTOP action of equipment receiving power via these connections.

Pre-wired cabling connects to the circuit boards, as noted above.

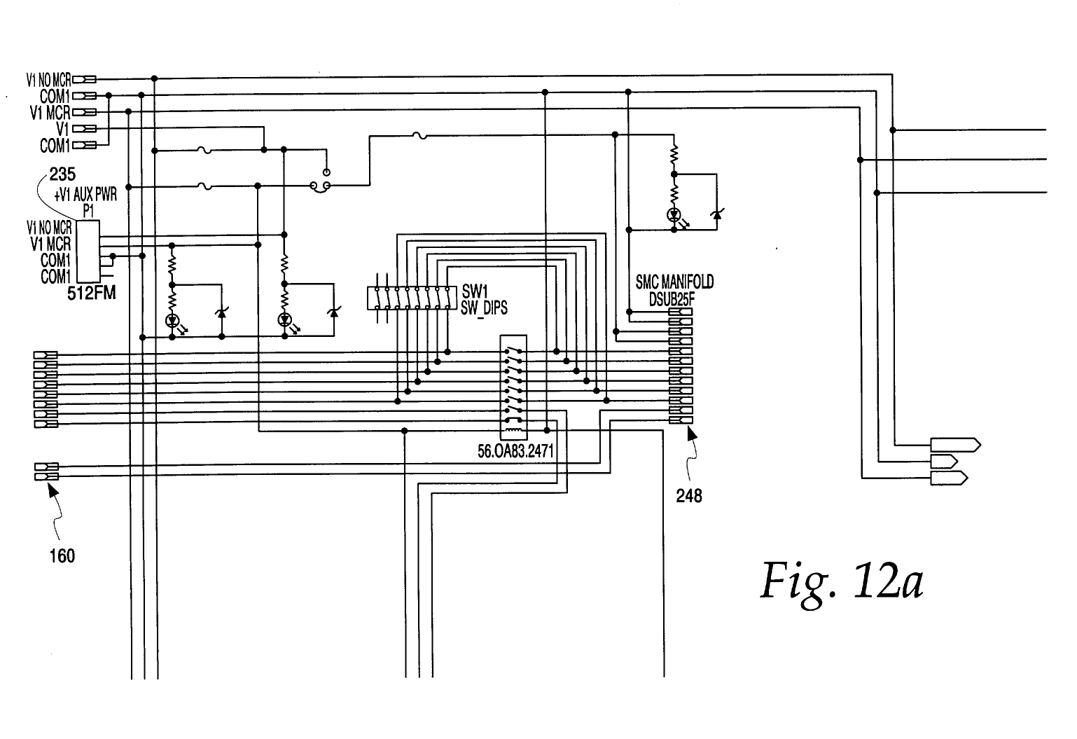

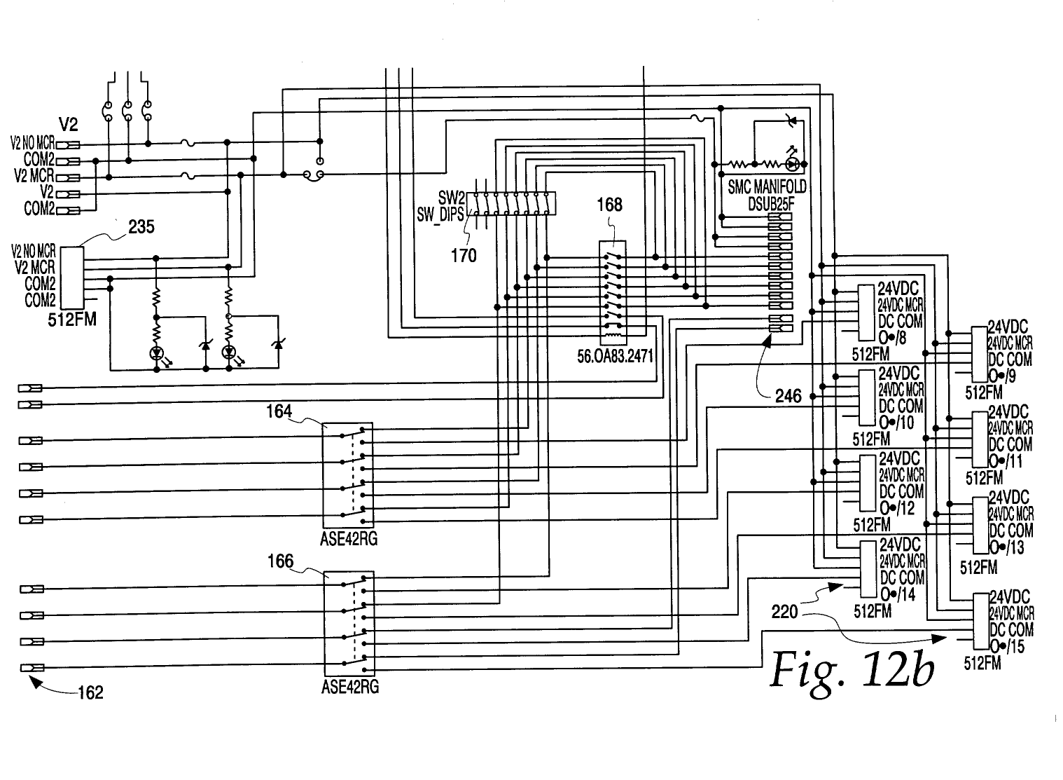

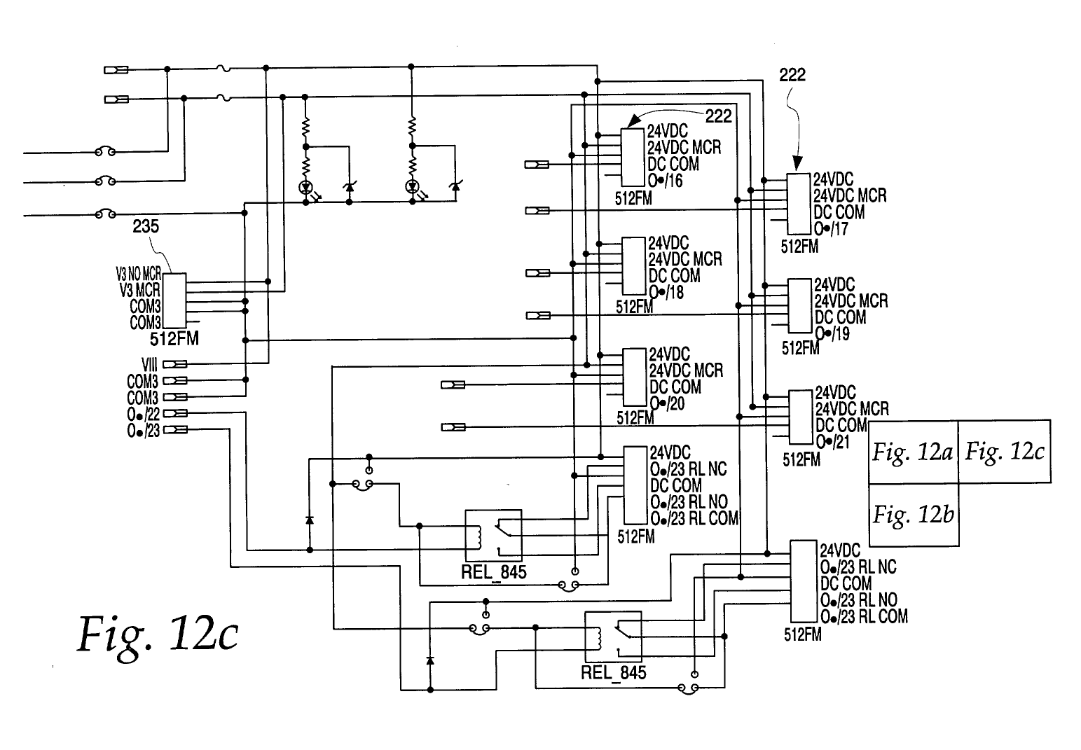

Isolated independently fused auxiliary power is also provided (see FIG. 12).

Referring now to FIGS. 11-13, the I/O cards are dipswitch settable, in banks of 8, for sourcing or sinking operation. All general purpose I/O connectors are 5 pins, industry standard terminations.

The input PCB is shown in FIG. 11. The circuit 120 of FIG. 11 is repeated three times, one for each input V1, V2, V3 of FIG. 14. The circuit 122 serves the V4 input.

I: 0-I: 7 (226) are provided with industry standard, circular, multi-conductor with DC power conductors for connection to a multi-port junction box. All inputs are dipswitch configurable via dual inline packaged (DIP) switches 124, 126 (see FIG. 11), for PNP, NPN or other operation provided through pins 4 and 2 on an industry standard I/O connector. Outputs 215 go to a connector on the rear of the I/O panel, which may be connected by a cable to a controller, either on the MPP or remotely located.

Ten (10) conductors are provided on an aux connector, and are pinned through the input board to terminal blocks inside the control enclosure 96. Independent connections (e.g., 130) for each Com voltage for the input card are provided. +24V to power sensors, etc. are fused for each bank of 8 inputs. The first 9 conductors of the aux terminal 208 are dip-switch (126) configurable to provide a bussed, straight through connection to a DB9 (com 1) connector 127.

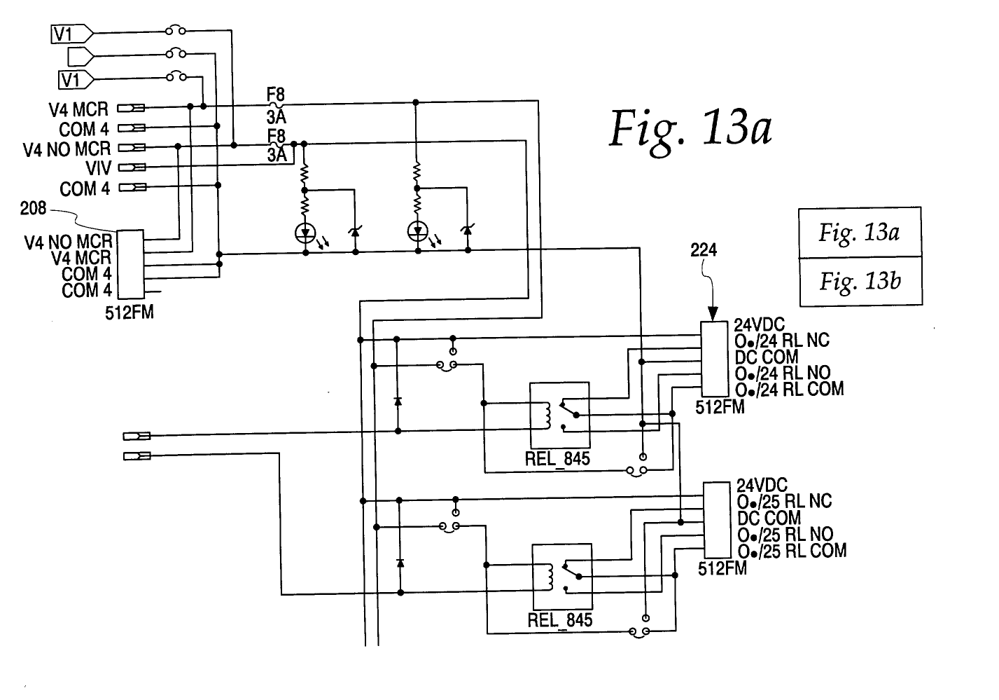

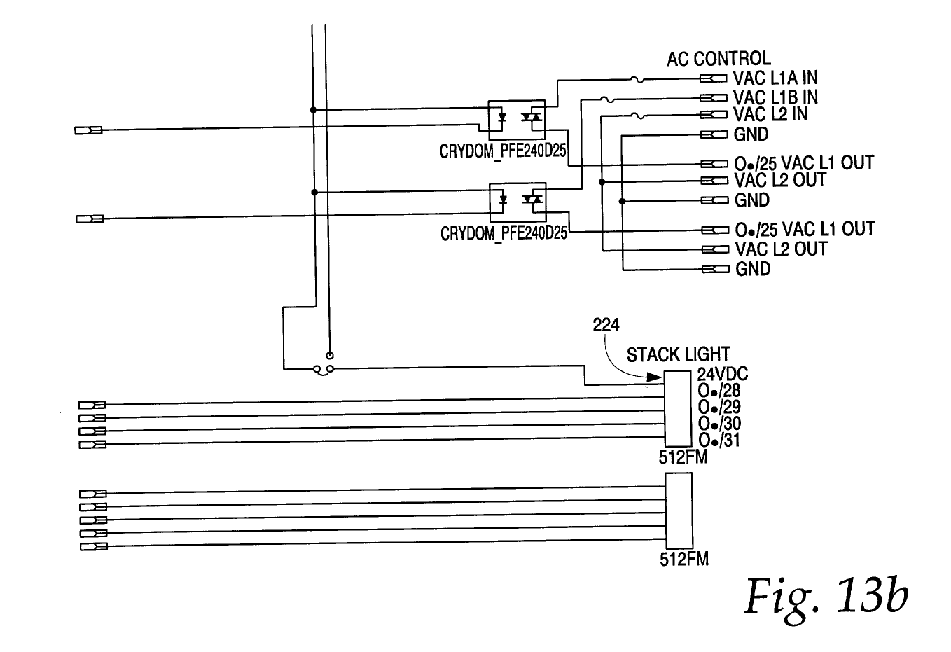

The output PCB is shown in FIGS. 12 and 13. The first 8 outputs (O: 0-O 7) 160 are dedicated to the manifold 1-db25 connector 246. The next 8 outputs (O: 8-O: 15) 162 are dipswitch (164-170) configurable to connect to the front panel connectors 220 for typical input termination or to the manifold 2-db25 connector 248 the same as the first 8. The manifold connectors carry control signals to pneumatic control systems.

Outputs O 16-O: 21 220 are designated for general output termination. Outputs O: 22-O: 25 222, 224 (see also FIG. 13) are selectable between general output termination or 4 amps, relay, NC and NO operation on pins 2 and 4 respectively. O: 26-O: 27 (FIG. 13) are individually selectable to the respective output connectors or to solid-state relays capable of switching 10A inductive or resistive loads. These appear on 1 split duplex outlet mounted in the back of the I/O interface cover, and are configurable for interrupted or uninterrupted AC power. O: 28-O: 31 (224) (FIG. 13) are terminated on pins 1-4 respectively, with pin 5 being common, on connector P28 for connection to a stack light.

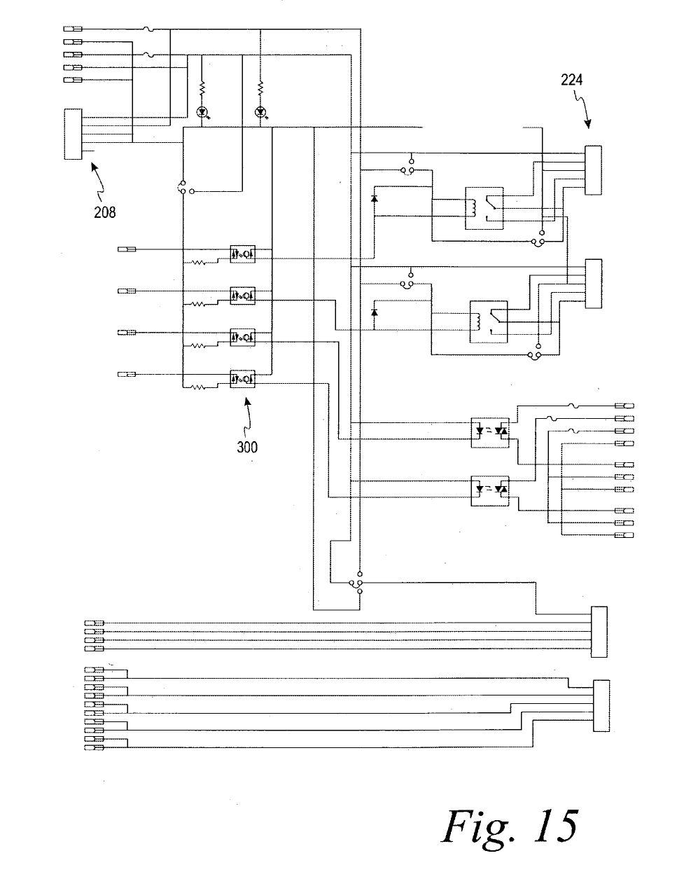

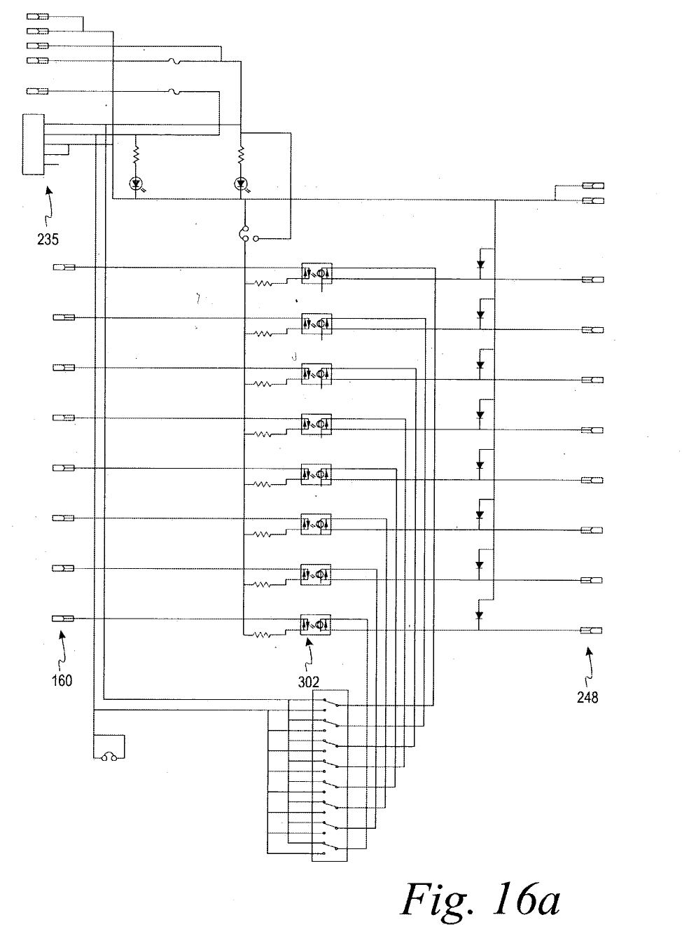

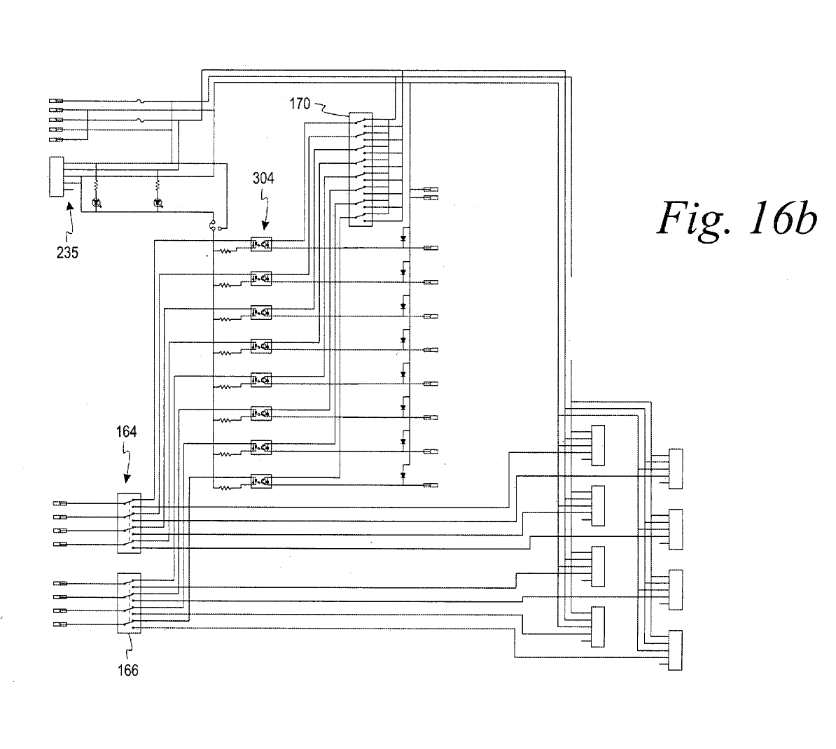

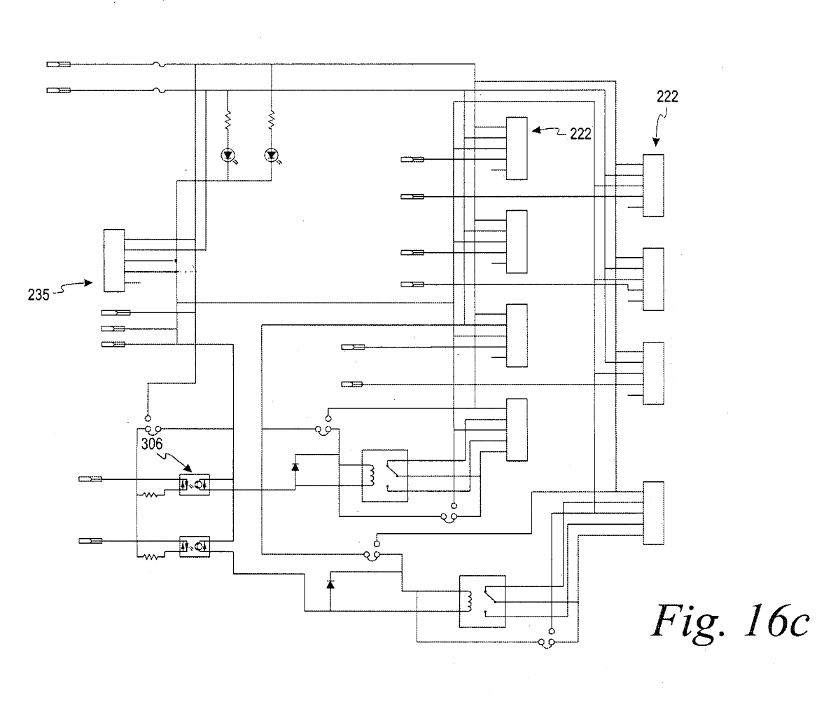

FIG. 15 shows another form of the output circuit of FIGS. 13A-13B, adding opto-isolatros 300. FIGS. 16A-16C show another form of the output circuits of FIGS. 12A-12C, omitting relays and adding opto-isolators 302, 304 and 306.

All outputs are individually, dipswitch settable to e-stop interrupted (“safety critical”) or e-stop uninterrupted (“non-safety critical”) DC power. Each bank of 8 outputs is fused separately for both interrupted and uninterrupted output DC power. The input and output PCB fuses 238 are visible located behind a front access cover 244 to the right of the I/O connectors (see FIG. 14).

A plugable, screw terminal type connector is provided on the back of the output PCB for high power AC or DC connection and/or switching.

Power inputs to the I/O interface from the control enclosure include four isolated inputs and four isolated outputs, which may be connected if required for signal isolation. In the embodiment shown these comprise MCR (master control relay) inputs:

Non-MCR +24V

MCR +24V

Non-MCR 120 VAC −15 amps

MCR 120 VAC

Two front mount, auxiliary AC outlets 240, 242 are provided. Two rear mount switched via PLC AC outlets are provided on the I/O interface.

Summarizing the above discussion, as shown in FIG. 14, the external I/O for the system is provided on a 19″ rack mount compatible I/O module This module provides connections for pneumatics manifolds, AC connections, DC connections, as well as Eurofast connectors for sensors and outputs. The functionality of the I/O board is summarized below:

| | SIGNAL | | |
|---|---|---|---|
| | TYPE | QTY | NOTES |
| 1 | PNP/NPN | 24 | Eurofast connectors. +V fused on board |
| | Input | | |
| 2 | PNP/NPN | 8 | MiniFast 14 pin connector (208) for connection |
| | Input | | to Turck 8 position junction box with standard |
| | | | cordset. Allows remote location of inputs. |
| 3 | Pneumatic | 8 | Manifold 1 ribbon connector (248), bank |
| | Valve | | fused on board. MCR or non MCR action dip |
| | Outputs | | switch selectable. |
| 4 | Pneumatic | 8 | Manifold 2 ribbon connector (246), bank |
| | Valve | | fused on board. MCR or non MCR action |
| | Outputs | | jumper selectable. Jumper select pneumatic |
| | | | manifold or Eurofast connector (8 output). |
| | | | MCR or non MCR action dip switch selectable |
| | | | for each output. |
| 5 | NPN | 8 | Eurofast connectors. +V fused on board. |
| | Outputs | | Dip switches select pnuematic manifold 2 or |
| | | | Eurofast for up to 8 outputs (each switch |
| | | | controls 4 outputs). MCR or non MCR action |
| | | | dip switch selectable for each output. |
| 6 | Switched 2 | | Relay, fuse, and LED provided on board. |
| | AC | | MCR or non MCR action jumper selectable |
| 7 | Un- | 2 | Fuse and LED provided on board. MCR or |
| | Switched | | non MCR action jumper selectable |
| | AC | | |
| 8 | Switched | 4 | Relay, fuse, and LED provided on board. |
| | +24 Vdc, | | MCR or non MCR action jumper selectable. |
| | 4 amps each | | Size relays for 4 amps each. |
| | relay | | Size power supply for actual usage. |
| 9 | Un- | 6 | MCR or non MCR action jumper selectable. |
| | switched | | Fuse and LED provided on board. These |
| | +24 Vdc, | | connectors allow easy connections to provide |
| | 2 amps | | power for external devices Any desired |
| | | | voltages can be used. |
| 10 | NPN | 6 | Eurofast connectors. +V fused on board. |
| | Outputs | | MCR or non MCR action dip switch |
| | | | selectable for each output. |
| 11 | Relay | 4 | Standard 5 pin connector for Stack |
| | Outputs | | lite and horn. |

The modular process platform (MPP)can be supplied with one of three standard control architectures including PLC-based, PC-based, and PC-based with motion controller (e.g., Adept) for high end vision guidance and inspection application. This allows users to select the controller best suited for an application while staying with a common machine base and positioning axes technology. The controller may be housed in the slide-out-drawer/enclosure 96, or be housed remotely from the MPP.

A brief summary of each of the control platform's capability and configuration is provided below.

The PLC-based system can be used for application requiring point to point motion with no vision capability. The system is extremely simple to use and maintain and provides a rugged, robust control platform. The system software is focused on minimizing the training required for operation and maintenance of the work-cell. The major components comprising the PLC-based system are briefly described below:

The PLC (Programmable Logic Controller) sends discrete points to the MPP's and commands moves on the axes via serial communication. The system can be programmed in ladder logic or Basic. Motion is not coordinated but all axes are commanded to move at approximately the same time. All sequencing and control of the work-cell is controlled by the PLC. This system may have a 9 slot rack and support up to 224 I/O within the standard base. If Devicenet or other serial network is used, more I/O can be added. The PLC may be a Direct Logic DL205PLC, for example.

The touch screen 84 is used to jog the axes, teach points, and edit process screens. Process control screens can be tailored to fit almost any process. Status and messages to the operator are displayed to minimize training required for operation of the machine. A position table containing up to 256 points is stored in the PLC's memory. Separate process parameters for each position are stored inside the PLC's memory. The PLC may control a combination of MPP's using custom, or pneumatic axes, which move to position based on serial or discrete commands from the PLC.

Standardized ports for AC, outputs, and sensor interface are included inside the MPP for almost instant connection of sensors, outputs, and feeders. Auxiliary air (pneumatic) and AC connections are provided included on front of machine. SMEMA interface connections for in-line conveyor operation may also be supplied.

The system may be programmed in industry standard ladder logic or flow charts. This control platform cannot be accessed via Ethernet network and does not support coordinated motion and contouring applications. However, simplicity, low cost, and ruggedness make it the idea choice for simple to medium complexity assembly processes.

The PC-based system can be used for applications requiring point to point motion with limited vision guidance capability. This system also supports vision inspection when guidance is not required. The system offers all of the advantages of PC connectivity and is idea for medium to low cost applications where network connectivity is required. The system uses rugged industrial quality I/O and features on-line documentation and help menus. The system software design methodology focuses on minimizing the training required for operation and maintenance of the work-cell. The PC-based system is briefly described below.

The PC sends discrete points to the SmartModules and commands moves on the axes via serial communication. Motion is not coordinated but all axes are commanded to move at approximately the same time. The system provides hard drive storage, floppy disk access, and CDRW ROM access.

The PC's monitor (e.g., flat panel) and trackball are used to jog the axes, teach points, and edit process screens. Process control screens can be tailored to fit almost any process. Comprehensive help screens and on-line documentation are the major advantages of this platform versus other low cost solutions. (Touch screen optional.)

The system connects via Ethernet to the same PLC rack via an Ethernet coupler (installed in place of PLC) and I/O system as the PLC-based system (see description above)

Databases containing location and process variables are stored in the PC's memory. Separate process parameters for each position are stored inside the PC's memory. Multiple process setups can easily be selected via menu.

The PC may control combinations of MPPs having custom or pneumatic axes, which move to position based on serial commands from the PC.

Standardized ports for AC, outputs, and sensor interface are included inside the MPP for almost instant connection of sensors, outputs, and feeders. Auxiliary air (pneumatic) and AC connections are provided included on front of machine. SMEMA interface connections for in-line conveyor operation are supplied standard.

The system can be supplied with a variety of vision inspection systems including Adept's Hexide vision system, Matrox, Cognex, DVT, or Keyence. The system can be supplied with a printer if required. A process log tailored to your process can be logged to the hard drive, CDRW, floppy, or printed on hard copy. The system can be programmed in Visual Basic, optional Think and Do control available.

This control platform allows access to Internet or Ethernet but does not support coordinated motion and contouring or vision guided applications. Its simplicity, low cost, and ease of use make it the ideal choice for simple to medium complexity assembly processes.

The PC with motion controller-based platform offers the ultimate in performance, expandability, and flexibility. The system excels in applications where complex coordinated motion, path following, vision guidance and inspection, or conveyor tracking is required. The system offers all of the advantages of PC connectivity and the rugged dependability and performance provided by a motion controller, for example, Adept controls and axes. This platform is ideal for medium to complex applications where expandability, vision guidance, high performance, and network connectivity is required. The system may utilize Adept's industrial quality I/O and features on-line documentation and help menus. The system software is focused on minimizing the training required for operation and maintenance of the work-cell.

An Adept Controller may be used to control position of the MPP axes, provide vision capability, and control the work-cell. The controller provides 28 tasks and abundant I/O for real time control and allows unparalleled processing power and flexibility. Motion is highly coordinated and optimized for speed. A PC monitor (e.g., flat panel) is used for operator interface to the controller.

The operator interface and mass storage for the controller (e.g., Adept SmartController) is provided via a PC and monitor. The PC's monitor and trackball or a teach pendant can be used to jog the axes, teach points, and edit process screens. Process control screens can be tailored to fit almost any process. Comprehensive help screens, operating messaging, and on-line documentation a major features of this platform. The PC provides hard drive storage, floppy disk access, and CDRW ROM access. (Touch screen optional.)

The system connects via DeviceNet to same PLC rack via DeviceNet coupler (installed in place of the PLC logic controller) and I/O system as the PLC-based system (see description above). In additional, ruggedized Adept I/O technology is used to provide industrial digital and analog I/O options for the MPP. DeviceNet connectivity is supplied standard on the cell.

Databases containing a virtually unlimited number of location is stored in the controller's memory. Separate process parameters for each position are stored inside the controller's memory. Multiple process setups can easily be selected via menu.

A combination of MPPs with custom or pneumatic axes which move to position based on serial or discrete commands from the controller.

Standardized ports for AC, outputs, and sensor interface included inside the work-cell for almost instant connection of sensors, outputs, and feeders Auxiliary air (pneumatic) and AC connections are provided included on front of machine. SMEMA interface connections for in-line conveyor operation are supplied standard.

The system can be supplied with a vision system such as Adept's VXL vision system. This system offers a set of easy to use state of the art vision tools. The system includes an extremely accurate and easy to use object finder based on patented modeling technology. Repeatability of 1/40^{th} of a pixel is possible using this vision tool. The system can also be supplied with a printer if required.

A process log tailored to a given process can be logged to the hard drive, CDRW, floppy, or printed on hard copy. The system can be programmed in Adept V+, Adept AIM, Visual Basic (PC front end only).

This control platform allows access to Internet, Ethernet, and PC functionality and supports all of the features provided by the Adept platform. Its simplicity, ease of use, and high performance make it the ideal choice for simple to extremely complex assembly processes.

It is thus believed that the operation and construction of the present invention will be apparent from the foregoing description.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

What is claimed is:

1. A modular process platform system comprising:
a frame;
a machine base mounted to said frame;
an input/output panel mounted to said frame, said input/output panel having a plurality of connectors configured for receiving mating connectors from a machine capable of being mounted to said machine base and from a controller for controlling operation of said machine; and
means for mapping said connectors to any of a plurality of different input/output configurations;
whereby said system is configurable for accommodating any of a plurality of different machines having different input/output configurations, without requiring wiring customized to a particular input/output configuration.

2. The system of claim 1 wherein said input/output panel includes reconfigurable switching elements for mapping an input/output configuration.

3. The system of claim 1 and further including a system controller mounted to said frame

4 The system of claim 1 and further including a system controller located remotely from said frame.

5. The system of claim 1 and further including a system controller for controlling the operation of a machine capable of being mounted to said machine base, and wherein said controller comprises one of a personal logic controller based system and a personal computer based system.

6. The system of claim 1 and further including a video monitor mounted to said frame.

7. The system of claim 5 wherein said controller comprises a PC-based controller and further including a video monitor.

8. The system of claim 5 and further including a network interface operatively coupled with said controller.

9. The system of claim 1 wherein the connectors of said input/output panel include a pneumatic manifold connector and means for mapping an input/output configuration for said manifold connector.

10. The system of claim 2 wherein said switching elements include switching elements for mapping two or more power supply voltages to said input/output configuration.

11. The system of claim 8 wherein said I/O panel is mapped to a controller via a serial network.

12. The system of claim 1 and further including an electronics enclosure mounted to said frame, said frame including one or more wireways for interconnecting said input/output panel with electronics located in said electronics enclosure

13. The system of claim 1 and further including a protruding, cantilevered work surface enclosure extending laterally from said frame for accommodating one of a conveyor and a manually loadable work station.

14. A method of carrying out an industrial process comprising:
installing tooling for carrying out said industrial process in a modular platform;
providing said modular platform with a configurable input/output panel having a plurality of connectors configured for receiving mating connectors from said tooling and mappable to a controller located in said modular platform or remotely from said modular platform; and
mapping said input/output configuration to accommodate said tooling mounted to said platform without requiring wiring customized to a particular input/output configuration.

15. The method of claim 14 wherein said mapping comprises using reconfigurable switching elements on said input/output panel.

16. The method of claim 14 and further including mounting a system controller to said platform.

17. The method of claim 14 and further including locating a system controller remotely from said modular platform.

18. The method of claim 14 and further including controlling the operation of a machine capable of being mounted to said machine base, using a controller comprising one of a programmable logic controller based system and a personal computer based system.

19. The method of claim 14 and further including mounting a video monitor to said platform.

20. The method of claim 18 and further including operatively coupling a network interface with said controller.

21. The method of claim 14 including mapping an input/output configuration for a manifold connector.

22. The method of claim 15 including mapping two or more power supply voltages to said input/output configuration.

23. The method of claim 21 including mapping said input/output panel is mapped to a controller via a serial network.

24. A method of claim 14 and further including interconnecting an electronics enclosure said input/output panel with electronics located in an electronics enclosure mounted to said platform.

25. A method of claim 14 and further including accommodating one of a conveyor and a manually loadable work station using a protruding, cantilevered work surface enclosure extending laterally from said frame.

26. A modular process system for carrying out an industrial process, comprising:
means for mounting tooling for carrying out said industrial process in a modular platform;
means for receiving, at a configurable input/output panel having a plurality of connectors, mating connectors from said tooling and maping said connectors to a controller located in said modular platform or remotely from said modular platform; and
means for mapping said input/output configuration to accommodate said tooling mounted to said platform without requiring wiring customized to a particular input/output configuration

27. The system of claim 26 wherein said input/output panel includes reconfigurable switching comprising said means for mapping an input/output configuration.

28 The system of claim 26 and further including system controller means mounted to said modular platform.

29. The system of claim 26 and further including system controller means located remotely from said modular platform.

30. The system of claim 26 and further including system controller means for controlling the operation of a machine capable of being mounted to said modular platform, and wherein said controller means comprises one of a programmable logic controller based system and a personal computer based system.

31. The system of claim 26 and further including a video monitor mounted to said frame.

32. The system of claim 30 wherein said controller means comprises a PC-based controller and further including a video monitor.

33. The system of claim 30 and further including a network interface operatively coupled with said controller means.

34. The system of claim 26 wherein the connectors of said input/output panel include a pneumatic manifold connector and means for mapping an input/output configuration for said manifold connector.

35 The system of claim 27 wherein said switching means include switching means for mapping two or more power supply voltages to said input/output configuration.

36. The system of claim 33 wherein said input/output panel is mapped to a controller via a serial network.

37. The system of claim 26 and further including an electronics enclosure mounted to said frame, said frame including one or more wireways for interconnecting said input/output panel with electronics located in said electronics enclosure.

38. The system of claim 26 and further including a protruding, cantilevered work surface enclosure extending laterally from said modular platform for accommodating one of a conveyor and a manually loadable work station.

39. The system of claim 1 wherein said means for mapping includes means for mapping safety critical and non-safety critical DC power.

40. The method of claim 14 further including mapping safety critical and non-safety critical DC power.

41. The system of claim 26 wherein said input/output panel includes means for mapping safety critical and non-safety critical DC power.
